(19) United States
(12) Patent Application Publication
(10) Pub. No.: US 2008/0265196 A1
(43) Pub. Date: Oct. 30, 2008

(54) VALVES INCLUDING AN INSULATING MEMBER AND METHODS OF MANUFACTURE

(75) Inventor: Jim Hoffman, Chandler, AZ (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 11/741,011

(22) Filed: Apr. 27, 2007

(51) Int. Cl. F16K 23/00

(52) U.S. Cl. 251/143; 251/142; 29/890.124

(57) ABSTRACT

Valves are provided that include a flowbody, a sealing element, and an insulating member. The flowbody has a channel and an outer surface. The sealing element is disposed in the flowbody channel. The insulating member surrounds the flowbody and includes an inner surface and an annular spacer extending radially inwardly therefrom and integrally formed therewith. The annular spacer is in contact with the flowbody outer surface to thereby form an airgap between the insulating member inner surface and the flowbody outer surface. Methods of manufacturing the valves are also provided.

### TECHNICAL FIELD

The inventive subject matter relates to valves and, more particularly, to valves including an insulating member and methods of manufacture.

### BACKGROUND

Air distribution systems may be used to direct air from one portion of an aircraft to another. In some aircraft configurations, the air distribution system includes one or more inlet ducts that receive air from an air source and one or more outlet ducts in flow communication with the inlet ducts that exhaust the received air to a desired area within the aircraft. Conventionally, one or more valves are positioned between the inlet and outlet ducts to distribute the air between the two or more outlet ducts.

In one configuration, the air distribution system is used to distribute air from a jet engine to an air conditioning system. Air from the jet engine is typically high in temperature (e.g., about 550° C.), and may be used by the air conditioning system, which provides warm or cool air to various sections of an aircraft cabin. The valves of the air distribution system regulate the flow or pressure of the engine air to the air conditioning system. Each valve includes a flowbody, a sealing element disposed therein, and an actuator coupled thereto. The actuator regulates the movement of the sealing element to thereby cause the valve to be fully or partially opened or closed.

Because the engine air is relatively high temperature, heat transfers to the flowbody when the air flows therethrough. However, if the temperature of the flowbody is too high, it may heat fluids and vapors that contact it to undesirable temperatures. To further safeguard against such occurrences, the flowbody is typically covered with a thermal insulation device. The thermal insulation device, conventionally made up of an insulating material surrounded by a sheet of metal, is in direct contact with the flowbody, which maintains or lowers the temperature of the device outer surface while maintaining thermal energy in the air. Although valves having these conventional layers operate sufficiently in some systems, they may not in operate as efficiently in others.

Accordingly, there is a need for a valve that has an improved ability over conventional valves to maintain thermal energy of the air flowing therethrough within a desired range during aircraft operation, without heating fluids and vapors that contact it to undesirable temperatures. Additionally, it would be desirable for the valve to be relatively inexpensive to manufacture and simple to install into existing aircraft.

### BRIEF SUMMARY

The inventive subject matter provides valves and methods of manufacturing the valves.

In one embodiment, and by way of example only, the valve includes a flowbody, a sealing element, and an insulating member. The flowbody has an outer surface. The sealing element is disposed in the flowbody. The insulating member surrounds the flowbody and includes an inner surface and an annular spacer extending radially inwardly therefrom and integrally formed therewith. The annular spacer is in contact with the flowbody outer surface to thereby form an airgap between the insulating member inner surface and the flowbody outer surface.

In another embodiment, and by way of example only, the valve includes a flowbody, a butterfly plate, and an insulating member. The flowbody has a channel and an outer surface. The butterfly plate is disposed within the channel and rotationally mounted to the flowbody. The insulating member is disposed around the flowbody and includes an inner surface and an annular spacer extending radially inwardly therefrom and integrally formed therewith. The annular spacer is disposed concentric to the flowbody and in contact with the flowbody outer surface to thereby form an airgap between the insulating member inner surface and the flowbody outer surface.

In still another embodiment, by way of example only, a method of manufacturing a valve is provided. The method includes enclosing an outer surface of a flowbody with an insulating member, the insulating member including an inner surface and an annular spacer extending radially inwardly therefrom and integrally formed therewith, such that the annular spacer contacts the flowbody outer surface to thereby form an airgap between the insulating member inner surface and the flowbody outer surface.

Other independent features and advantages of the preferred valves and methods of manufacturing the valves will become apparent from the following detailed description, taken in conjunction with the accompanying drawings which illustrate, by way of example, the principles of the inventive subject matter.

### BRIEF DESCRIPTION OF THE DRAWINGS

FIG. 1 is a simplified schematic illustrating a portion of an aircraft air distribution system, according to an embodiment;

FIG. 2 is a cutaway view of a valve that may be implemented into the system depicted in FIG. 1, according to an embodiment;

FIG. 3 is a cross-sectional view of the valve taken along line 3-3 in FIG. 2, according to an embodiment; and

FIG. 4 is a cross-sectional view of the valve that may be implemented into the system depicted in FIG. 1, according to another embodiment.

### DETAILED DESCRIPTION OF A PREFERRED EMBODIMENT

The following detailed description of the inventive subject matter is merely exemplary in nature and is not intended to limit the inventive subject matter or the application and uses of the inventive subject matter. Furthermore, there is no intention to be bound by any theory presented in the preceding background of the inventive subject matter or the following detailed description of the inventive subject matter.

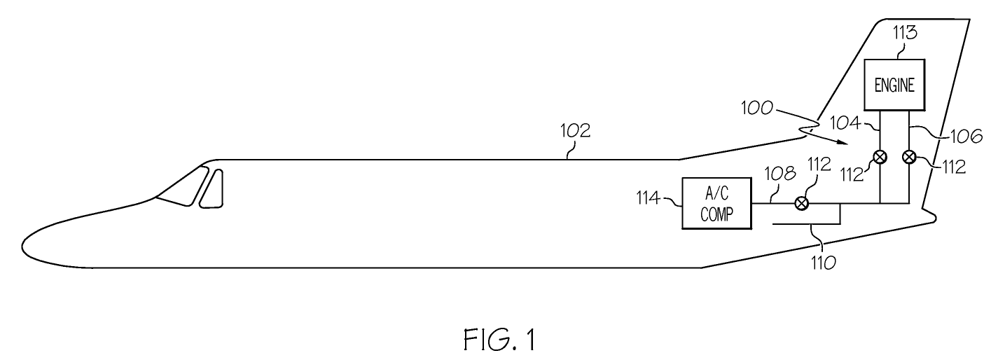

FIG. 1 is a simplified schematic diagram illustrating an air distribution system 100 disposed within an aircraft 102, according to an embodiment. The air distribution system 100 includes two inlet ducts 104, 106, two outlet ducts 108 and 110, valves 112 positioned in the ducts 104, 106, 108, 110, and an air conditioning component 114. The inlet ducts 104, 106 receive air from an air source, such as, for example, engine bleed air. The outlet ducts 108, 110 exhaust the air into the air conditioning component 114 and other sections of the aircraft 102. It will be appreciated that although two inlet ducts 104, 106, and two outlet ducts 108, 110 are depicted herein, fewer or more ducts may be incorporated into the system 100. The valves 112 are configured to open and close to regulate airflow and pressure through the ducts. In particular, the valves 112 may partially open, fully open, or close to thereby cause downstream pressure adjustment of the airflow or to cause change in air flow rate or temperature.

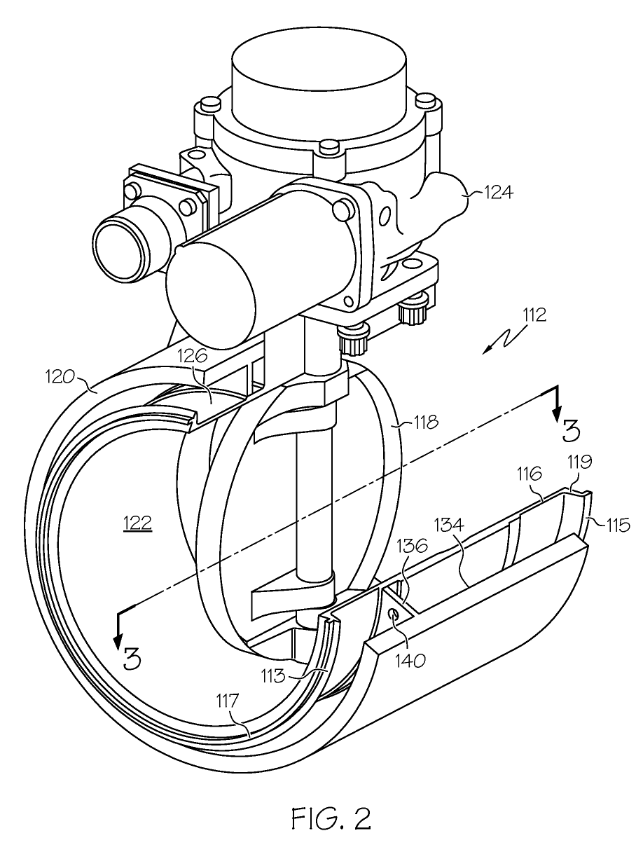

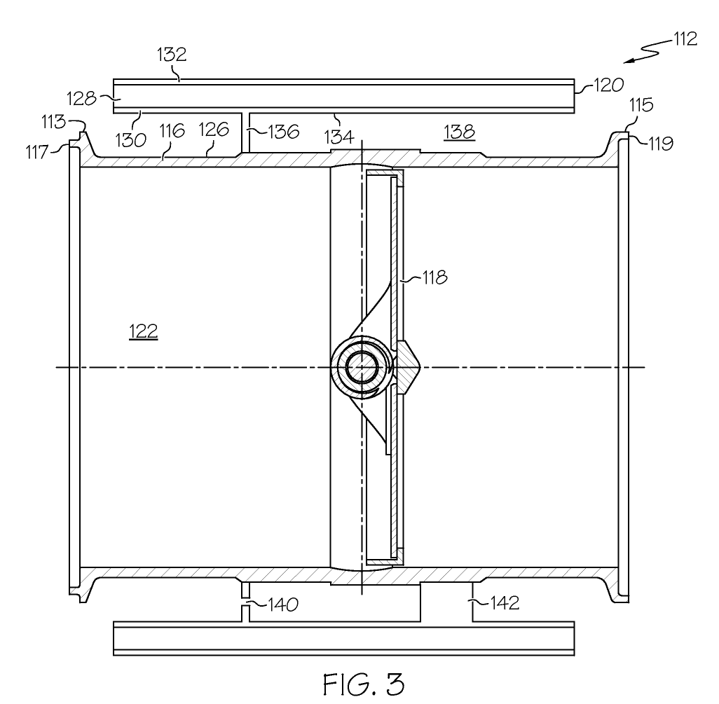

With reference now to FIGS. 2 and 3, FIG. 2 is a cutaway view of a valve 112 that may be implemented into the system 100, and FIG. 3 is a cross-sectional side view of the valve 112 taken along line 3-3 in FIG. 2, according to an embodiment. The valve 112 includes a flowbody 116, a sealing element 118, and an insulating member 120. The flowbody 116 has an outer surface 126 and a channel 122, and is generally made of a metallic material. Examples of suitable materials include aluminum alloys, steel or titanium, to name a few. Although one channel 122 is shown formed in the flowbody 116, it will be appreciated that more may alternatively be incorporated.

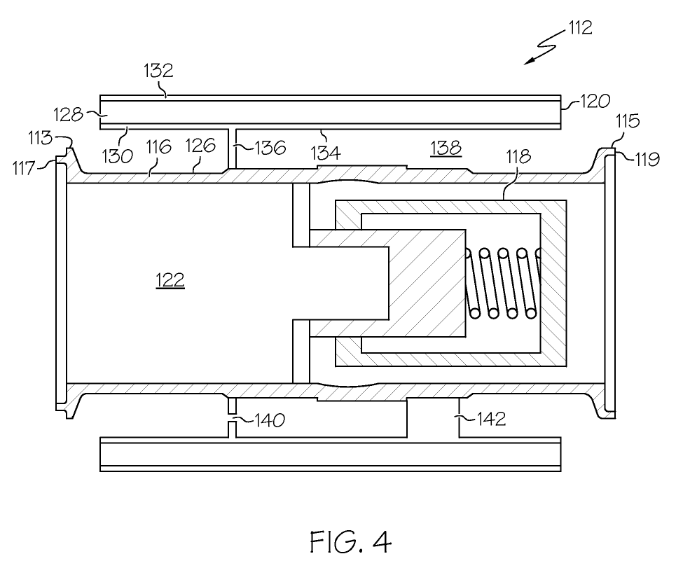

The sealing element 118 is disposed in the channel 122 and is mounted to the flowbody 1 16. In an embodiment, the sealing element 118 is a butterfly plate, as shown in FIGS. 2 and 3, and may be coupled to an actuator 124 that causes it to selectively open or close. The actuator 124 may be any actuating mechanism, including, but not limited to, an electric actuator, a pneumatic actuator, a hydraulic actuator, or a manual actuator. In another embodiment, the sealing element 118 is a poppet, as shown in FIG. 4 that is configured to slide axially through the flowbody 116, in response to pressure differentials thereacross.

In any case, to maintain at least the outer surface of the insulating member 120 at a desired temperature and to maintain the airflow at a particular temperature, the insulating member 120 is included around at least a portion of the outer surface 126 of the flowbody 116 and extends along a majority (e.g., greater than about 60%) of the axial length thereof. In an embodiment, a substantial portion of the flowbody outer surface 126 is surrounded by the insulating member 120. For example, the flowbody outer surface 126 may be surrounded by the insulating member 120 in its entirety. In another embodiment, the flowbody 116 includes two flanges 113, 115 extending radially outwardly from each of its ends 117, 119 that are used for clamping the flowbody 116 to one of the ducts. In this embodiment, the insulating member 120 may extend between, without covering, the flanges 113, 115.

The insulating member 120 may be a generally semi-rigid component that includes an insulation layer 128 disposed between an inner and outer layer 130, 132. The insulation may be made of an insulating material capable of insulating a flowbody 116 having temperatures as high as 550° C. Examples of suitable materials including fiberglass, calcium silicate, ceramic fiber, and mineral fiber silicates, just to name a few. The materials may be in any numerous suitable forms, including, but not limited to, sheets, perforated molded pieces, and cloth. In an embodiment, the insulation layer 128 may be between about 0.25 cm and about 4 cm thick. The inner and outer layers 130, 132 may be placed around the insulation layer 128 and may be made of a thermally conductive material capable of maintaining structural integrity when subjected to temperatures up to 1000 F. The layers 130, 132 may be, for example, a metallic material, including but not limited to aluminum alloy, steel, or titanium, and may be smooth, or corrugated,. In an embodiment, the inner and outer layers 130, 132 may be a unitary piece of material and may have a thickness that is between about 0.01 cm and 0.15 cm. In another embodiment, the layers 130, 132 may be separate and multiple pieces.

The insulating member 120 has an inner surface 134 and an annular spacer 136 extending radially inwardly therefrom. The annular spacer 136 contacts the flowbody outer surface 126 to thereby maintain an airgap 138 between the insulating member inner surface 134 and the flowbody 1 16. In an embodiment, the annular spacer 136 is configured such that a substantial portion of the insulating member inner surface 134 (e.g., at least about 80%) forms an airgap 138 with the flowbody outer surface 126. The annular shape of the spacer 136 may advantageously provide more surface area, as compared to other spacer shapes, to restrain the insulating member 120. As a result, the stress caused by vibration or other movement experienced by the insulating member 120 during operation or testing may be minimized. To equalize pressure, in the event of a pressure differential across the annular spacer 136, a vent opening 140 may be formed therein. Although one vent opening 140 is shown, more may alternatively be included.

The annular spacer 136 may be concentric to the flowbody 116. In an embodiment, the annular spacer 136 is integrally formed with the insulating member 120, which may desirably reduce part count and steps during manufacture of the valve 112. In still another embodiment, the annular spacer 136 is formed separately from and subsequently bonded to the insulating member 120. In still yet another embodiment, the annular spacer 136 may be bonded directly to the flowbody outer surface 126, alternatively, it may not be.

In addition to the annular spacer 136, other spacing components 142 may be included or integrally formed on the insulating member 120 proximate the annular spacer 136 to maintain the insulating member inner surface 134 a substantially uniform distance from the flowbody outer surface 126 (e.g., within at least about 20% uniformity). For example, one or more square-shaped spacers, one or more donut-shaped spacers, and/or one or more round spacers may be disposed thereon. In an embodiment, the distance of the airgap 138 between the insulating member inner surface 134 and the flowbody outer surface 126 may be between about 0.5 cm and about 2.0 cm. However, it will be appreciated that the particular airgap distance may depend on the particular size of the flowbody 116 itself and the thickness of the insulating member 120.

The valve 112 may be manufactured by enclosing an outer surface 126 of a flowbody 116 with an insulating member 120, where the insulating member 120 includes an inner surface 134 and an annular spacer 136 extending radially inwardly therefrom and integrally formed therewith, such that the annular spacer 136 contacts the flowbody outer surface 126 to thereby space the insulating member inner surface 134 apart from the flowbody outer surface 126. In one embodiment, the insulating member 120 may be formed into as two halves of a cylinder, the two halves may be joined to encapsulate the flowbody 116 therebetween, and the halves may be clamped together to form the cylinder. In another example, the cylinder may have a slit extending along its length that may be widened to allow the flowbody 116 to be inserted therethrough. In another embodiment, the insulating member 120 may be a flat sheet, and the flowbody 116 may be placed on the sheet. The sheet may then be rolled into a cylinder to surround the flowbody 116.

In another embodiment, an insulating member 120 is formed including an inner layer 130, an outer layer 132, and an insulation layer 128 therebetween, wherein the insulation layer 128 may be an insulator material and the inner and outer layers 130, 132 may be a metallic material. In another embodiment, the annular spacer 136 is integrally formed with the insulating member 120. In still another embodiment, the annular spacer 136 may be connected to the insulating member 120. In another embodiment, a sealing element 118 may be disposed in the flowbody 116. The sealing element 118 may be a butterfly plate or a poppet.

A valve 112 has now been provided that may be capable of maintaining the temperature of the air flowing therethrough within a desired range during aircraft operation, while also having an outer surface that is of a lower temperature than that of the air flowing through the flowbody 116. Additionally, the valve 112 may be relatively inexpensive to manufacture and simple to install into existing aircraft.

While the inventive subject matter has been described with reference to a preferred embodiment, it will be understood by those skilled in the art that various changes may be made and equivalents may be substituted for elements thereof without departing from the scope of the inventive subject matter. In addition, many modifications may be made to adapt to a particular situation or material to the teachings of the inventive subject matter without departing from the essential scope thereof. Therefore, it is intended that the inventive subject matter not be limited to the particular embodiment disclosed as the best mode contemplated for carrying out this inventive subject matter, but that the inventive subject matter will include all embodiments falling within the scope of the appended claims.

We claim:

1. A valve comprising:
a flowbody having an outer surface and a channel;
a sealing element disposed in the flowbody channel and configured to selectively move between an open and a close position; and
an insulating member surrounding the flowbody, the insulating member including an inner surface and an annular spacer extending radially inwardly therefrom and integrally formed therewith, the annular spacer disposed in contact with the flowbody outer surface to thereby form an airgap between the insulating member inner surface and the flowbody outer surface.

2. The valve of claim 1, wherein at least 80% of the insulating member inner surface forms the airgap with the flowbody outer surface.

3. The valve of claim 1, wherein the insulating member comprises an inner layer, an outer layer, and an insulation layer disposed therebetween, the inner layer and the outer layer comprise a metallic material, and the insulation layer comprises an insulator material.

4. The valve of claim 1, wherein the annular spacer is concentric to the flowbody.

5. The valve of claim 1, wherein the sealing element comprises a butterfly plate.

6. The valve of claim 1, wherein the sealing element comprises a poppet.

7. The valve of claim 1, wherein the insulating member inner surface is maintained a substantially uniform distance apart from the flowbody outer surface.

8. The valve of claim 7, wherein the insulating member further comprises a spacing component disposed proximate the annular spacer.

9. The valve of claim 8, wherein the spacing component is integrally formed with the insulating member.

10. The valve of claim 1, wherein the insulating member inner surface is spaced at least 0.5 cm apart from the flowbody outer surface.

11. The valve of claim 1, wherein the annular spacer includes a vent opening formed therein.

12. A valve comprising:
a flowbody having a channel and an outer surface;
a butterfly plate disposed within the channel and rotationally mounted to the flowbody; and
an insulating member disposed around the flowbody, the insulating member including an inner surface and an annular spacer extending radially inwardly therefrom and integrally formed therewith, the annular spacer disposed concentric to the flowbody and in contact with the flowbody outer surface to thereby form an airgap between the insulating member inner surface and the flowbody outer surface.

13. The valve of claim 12, wherein the insulating member comprises an inner layer, an outer layer, and an insulation layer disposed therebetween, the inner layer and the outer layer comprise a metallic material, and the insulation layer comprises an insulator material.

14. The valve of claim 12, wherein the insulating member inner surface is maintained a substantially uniform distance apart from the flowbody outer surface.

15. The valve of claim 12, wherein the annular spacer includes a vent opening formed therein.

16. A method of manufacturing a valve, the method comprising the steps of:
enclosing an outer surface of a flowbody with an insulating member, the insulating member including an inner surface and an annular spacer integrally formed therewith and extending radially inwardly therefrom, such that the annular spacer contacts the flowbody outer surface to thereby form an airgap between the insulating member inner surface and the flowbody outer surface; and
disposing a sealing element in a channel formed in the flowbody.

17. The method of claim 16, wherein the insulating member comprises a first half and a second half, and the method further comprises encapsulating the flowbody between the first half and the second half and clamping the first and second halves together.

18. The method of claim 16, further comprising forming the insulating member comprising an inner layer, an outer layer, and an insulation layer disposed therebetween, wherein the inner layer and the outer layer comprise a metallic material and the insulation layer comprises an insulator material.

19. The method of claim 16, further comprising coupling the sealing element to an actuator.

20. The method of claim 16, wherein the step of enclosing comprises enclosing the flowbody in the insulating member where the annular spacer includes a vent opening.
